(19) United States
(12) Patent Application Publication
(10) Pub. No.: US 2024/0402549 A1
(43) Pub. Date: Dec. 5, 2024

(54) DISPLAY PANEL, MANUFACTURING METHOD THEREFOR, AND DISPLAY APPARATUS

(71) Applicants: Fuzhou BOE Optoelectronics Technology Co., Ltd., Fuzhou, Fujian (CN); BOE Technology Group Co., Ltd., Beijing (CN)

(72) Inventors: Zecun ZENG, Beijing (CN); Tao FANG, Beijing (CN); Tianfeng ZHANG, Beijing (CN); Wenli FAN, Beijing (CN); Meiying LI, Beijing (CN); Jianhua HUANG, Beijing (CN)

(21) Appl. No.: 18/699,578

(22) PCT Filed: Jul. 4, 2023
(86) PCT No.: PCT/CN2023/105775

§ 371 Date: Apr. 8, 2024

(30) Foreign Application Priority Data
Jul. 28, 2022 (CN) 202210896851.3

(51) Int. Cl. G02F 1/1362; G02F 1/1333; G02F 1/1335; G02F 1/1339; G02F 1/1368

(52) U.S. Cl. CPC G02F 1/136209; G02F 1/133388; G02F 1/133531; G02F 1/1339; G02F 1/136222; G02F 1/136286; G02F 1/1368

(57) ABSTRACT

A display panel, a manufacturing method therefor, and a display device. The display panel comprises a display substrate and an opposite substrate opposite with each other, wherein both the display substrate and the opposite substrate cover the display region and the selected frame region; a liquid crystal layer between the display substrate and the opposite substrate, wherein the liquid crystal layer is at least located in the display region; a first polarizer on one side of the opposite substrate facing away from the liquid crystal layer, wherein the first polarizer covers the display region and the selected frame region; and a second polarizer on one side of the display substrate facing away from the liquid crystal layer.

### CROSS REFERENCE TO RELATED APPLICATIONS

The present disclosure is a National Stage of International Application No. PCT/CN2023/105775, filed Jul. 4, 2023, which claims priority to Chinese patent application No. 202210896851.3, filed with the China National Intellectual Property Administration on Jul. 28, 2022, which are hereby incorporated by reference in their entireties.

### TECHNICAL FIELD

The present disclosure relates to the field of display technology, and in particular to a display panel, a manufacturing method therefor, and a display apparatus.

### BACKGROUND

The liquid crystal display (LCD) apparatus has the advantages of light weight, low power consumption, high image quality, low radiation and easy portability. It has gradually replaced the traditional cathode ray tube display (CRT) apparatus, and is widely used in modern information equipment.

### SUMMARY

The specific solutions of a display panel, a manufacturing method therefor, and a display apparatus provided by embodiments of the present disclosure are as follows.

On the one hand, embodiments of the present disclosure provide a display panel, including a display region and a selected frame region located on at least one side of the display region, where the display panel includes: a display substrate and an opposite substrate opposite with each other, where both the display substrate and the opposite substrate cover the display region and the selected frame region; a liquid crystal layer between the display substrate and the opposite substrate, where the liquid crystal layer is at least located in the display region; a first polarizer on one side of the opposite substrate facing away from the liquid crystal layer, where the first polarizer covers the display region and the selected frame region; and a second polarizer on one side of the display substrate facing away from the liquid crystal layer, where the second polarizer covers the display region and the selected frame region, a light transmission axis of the second polarizer is crossed with a light transmission axis of the first polarizer; and at least one of the second polarizer, the first polarizer or the liquid crystal layer is configured to control the selected frame region to shield light.

In some embodiments, the above display panel provided by the embodiment of the present disclosure further includes: a first sealant and a second sealant; where the first sealant surrounds the display region and an edge of the selected frame region adjacent to the display region; and the second sealant separates the display region from the selected frame region.

In some embodiments, in the above display panel provided by embodiments of the present disclosure, the liquid crystal layer has no pattern in the selected frame region.

In some embodiments, in the above display panel provided by embodiments of the present disclosure, the opposite substrate includes a black matrix arranged towards the liquid crystal layer, the black matrix extends from the display region to the selected frame region; and, in the selected frame region, the black matrix is disconnected along an extending direction of the selected frame region.

In some embodiments, in the above display panel provided by embodiments of the present disclosure, the opposite substrate further includes: a color resistance layer and an alignment layer arranged in sequence on one side of the black matrix facing the liquid crystal layer; the color resistance layer and the alignment layer are simultaneously arranged in the display region and the selected frame region; and at a position where the black matrix is disconnected in the selected frame region, both the color resistance layer and the alignment layer are disconnected.

In some embodiments, in the above display panel provided by embodiments of the present disclosure, the selected frame region includes a transition pattern region adjacent to the display region, and a patternless region on one side of the transition pattern region away from the display region; film layers of the opposite substrate in the transition pattern region and film layers of the opposite substrate in the display region are of the same layers and made of the same materials; and film layers of the display substrate in the transition pattern region and film layers of the display substrate in the display region are of the same layers and the same materials.

In some embodiments, in the above display panel provided by embodiments of the present disclosure, in a direction perpendicular to an extension direction of the selected frame region, a ratio of a width of the transition pattern region to a width of the selected frame region is greater than 0 and less than 0.001.

In some embodiments, the above display panel provided by the embodiment of the present disclosure further includes: a first frame region provided with a gate driving circuit and a second frame region configured to bond chips, the first frame region is adjacent to the second frame region; the selected frame region is located on one side of the display region away from the first frame region, and/or, the selected frame region is located on one side of the display region away from the second frame region.

In some embodiments, in the above display panel provided by embodiments of the present disclosure, the first frame region and the second frame region respectively include light-shielding layers; on the same side of the display region, a first distance is provided between the first sealant and the second sealant; and the first distance is equal to a width of a light-shielding layer on an opposite side of the second sealant.

In some embodiments, in the above display panel provided by embodiments of the present disclosure, at least one of the first polarizer or the second polarizer includes a light-shielding structure; and the light-shielding structure at least partially overlaps the selected frame region.

In some embodiments, in the above display panel provided by embodiments of the present disclosure, the first polarizer and the second polarizer include polarizing base layers; and the light shielding structure is embedded in at least one of the polarizing base layers.

On the other hand, embodiments of the present disclosure provide a manufacturing method for the above-mentioned display panel, including: providing a display substrate of a first size and an opposite substrate of the first size; where the display substrate of the first size and the opposite substrate of the first size include the display region, the selected frame region on at least one side of the display region, and a cutting region on one side of the selected frame region away from the display region; forming a sealant on the opposite substrate of the first size, and instilling liquid crystal in at least the display region of the display substrate of the first size; pairing the display substrate of the first size and the opposite substrate of the first size to form a display panel of the first size including the liquid crystal layer; removing the cutting region of the display panel of the first size to obtain a display panel of a second size; and attaching the first polarizer on one side of the opposite substrate of the display panel of the second size, and attaching the second polarizer on one side the display substrate; where the light transmission axis of the second polarizer is crossed with the light transmission axis of the first polarizer; and at least one of the second polarizer, the first polarizer or the liquid crystal layer is configured to control the selected frame region to shield light to obtain the above display panel provided by the disclosed embodiments.

In some embodiments, in the above-mentioned manufacturing method provided by embodiments of the present disclosure, the forming the sealant on the opposite substrate of the first size, and instilling liquid crystal in at least the display region of the display substrate of the first size, includes: forming a first sealant on edges of the opposite substrate of the first size in a complete circle; and at the same time, forming a second sealant on an edge of the selected frame region adjacent to the display region; where the first sealant surrounds the display region and an edge of the selected frame region adjacent to the display region; and the second sealant separates the display region from the selected frame region; and outside the selected frame region, instilling liquid crystal at a position corresponding to the display region enclosed by the first sealant and the second sealant on the display substrate of the first size.

In some embodiments, in the above-mentioned manufacturing method provided by embodiments of the present disclosure, the providing the display substrate of the first size and the opposite substrate of the first size, further includes: forming film layers of the display substrate of the first size in the display region, the selected frame region on at least one side of the display region, and the cutting region on one side of the selected frame region away from the display region by using a mask corresponding to the display substrate of the first size; and making film layers of the opposite substrate of the first size in the display region, the selected frame region and the cutting region by using a mask corresponding to the opposite substrate of the first size.

In some embodiments, in the above-mentioned manufacturing method provided by embodiments of the present disclosure, after providing the opposite substrate of the first size and before forming the sealant on the opposite substrate of the first size, the method further includes: Disconnecting, along the extension direction of the selected frame region, the film layers in the selected frame region on the opposite substrate of the first size.

In some embodiments, in the above-mentioned manufacturing method provided by embodiments of the present disclosure, the providing the display substrate of the first size and the opposite substrate of the first size, further includes: forming film layers of the display substrate of the first size in the display region and a transition pattern region by using a mask corresponding to the display substrate of the first size and an exposure baffle that blocks the selected frame region and the cutting region; and forming film layers of the opposite substrate of the first size in the display region and the transition pattern region by using a mask corresponding to the opposite substrate of the first size and the exposure baffle; where the selected frame region is located on at least one side of the display region, the cutting region is located on one side of the selected frame region away from the display region, and the transition pattern region is located in the selected frame region and adjacent to the display region; and a width of the transition pattern region in a direction perpendicular to an extension direction of the selected frame region is positively correlated with a distance from the mask to the exposure baffle.

In some embodiments, in the above-mentioned manufacturing method provided by embodiments of the present disclosure, after removing the cutting region of the display panel of the first size to obtain the display panel of the second size, and before attaching the first polarizer on one side of the opposite substrate of the display panel of the second size, and attaching the second polarizer on one side the display substrate, the method further includes: providing the first polarizer and the second polarizer; where at least one of the first polarizer or the second polarizer includes a light-shielding structure arranged corresponding to the selected frame region.

On the other hand, embodiments of the present disclosure provide a display apparatus, including the above display panel provided by the embodiments of the present disclosure.

### BRIEF DESCRIPTION OF FIGURES

FIG. 1 is a schematic structural diagram of a display panel in the related art.

FIG. 2 is a schematic structural diagram of an opposite substrate in the related art.

FIG. 3 is a schematic structural diagram of a color filter substrate in the related art.

FIG. 4 is a schematic diagram of cutting the opposite substrate.

FIG. 5 is a schematic diagram of the opposite substrate after cutting.

FIG. 6 is another schematic structural diagram of a display panel in the related art.

FIG. 7 is a cross-sectional view along a line a-a′ in FIG. 6.

FIG. 8 is a schematic structural diagram of a display panel provided by embodiments of the present disclosure.

FIG. 9 is a cross-sectional view along a line b-b′ in FIG. 8.

FIG. 10 is a cross-sectional view along a line c-c′ in FIG. 8.

FIG. 11 is a cross-sectional view along a line d-d′ in FIG. 8.

FIG. 12 is a schematic diagram of a mask of a display panel provided by embodiments of the present disclosure.

FIG. 13 is a schematic diagram of an opposite substrate prepared using the mask shown in FIG. 12.

FIG. 14 is a schematic diagram of a display substrate prepared using the mask shown in FIG. 12.

FIG. 15 is a cross-sectional view of the display panel paired with FIG. 13 and FIG. 14, corresponding to the line c-c′ in FIG. 8.

FIG. 16 is another schematic structural diagram of a display panel provided by embodiments of the present disclosure.

FIG. 17 is a schematic diagram of cutting the opposite substrate in the display panel shown in FIG. 16.

FIG. 18 is a schematic diagram of the opposite substrate shown in FIG. 17 after cutting.

FIG. 19 is another schematic structural diagram of an opposite substrate provided by embodiments of the present disclosure.

FIG. 20 is a schematic diagram of a first polarizer provided by embodiments of the present disclosure.

FIG. 21 is a schematic diagram of a second polarizer provided by embodiments of the present disclosure.

FIG. 22 is another schematic structural diagram of a display panel provided by embodiments of the present disclosure.

FIG. 23 is a schematic diagram of cutting a display panel of a first size provided by embodiments of the present disclosure.

FIG. 24 is a schematic structural diagram of the opposite substrate in the display panel shown in FIG. 23.

### DETAILED DESCRIPTION

In order to make the purpose, technical solutions and advantages of embodiments of the present disclosure more clear, the technical solutions of the embodiments of the present disclosure will be clearly and completely described below in conjunction with the drawings of embodiments of the present disclosure. It should be noted that the sizes and shapes of the figures in the drawings do not reflect true proportions and are only intended to illustrate the present disclosure. And, the same or similar reference numbers throughout represent the same or similar elements or elements with the same or similar functions. In order to keep the following description of embodiments of the present disclosure clear and concise, the present disclosure omits detailed descriptions of well-known functions and components.

Unless otherwise defined, technical or scientific terms used herein shall have their ordinary meaning understood by a person of ordinary skill in the art to which the disclosure belongs. “First”, “second” and similar words used in the description and the claims of the disclosure do not indicate any order, quantity or importance, but are only used to distinguish different components. Words such as “include” or “comprise” mean that the elements or objects appearing before the word include the elements or objects listed after the word and their equivalents, without excluding other elements or objects. Words such as “inside”, “outside”, “up”, “down” are only used to express relative positional relationships. When the absolute position of the described object is changed, the relative positional relationship may also be changed accordingly.

In recent years, the demand for display screens in the market has shown characteristics of customization and diversification. Bar screens or square screens of different sizes and aspect ratios are used in commercial display advertising machines, electronic whiteboard conferences, rail transit and other fields. The demand for these bar screens is often small in quantity. If it is developed in the form of a new product, a complete set of masks will need to be produced. The development cost will be very high, and the recovery period of the development cost will be very long, and the cost may even be unrecoverable. In order to save costs, the display screen of the target size can be prepared by cutting the existing mass-produced LCD screen.

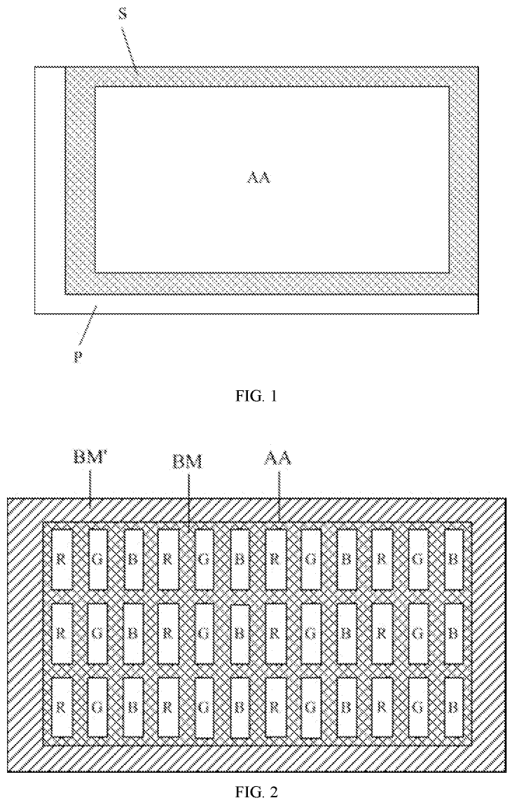

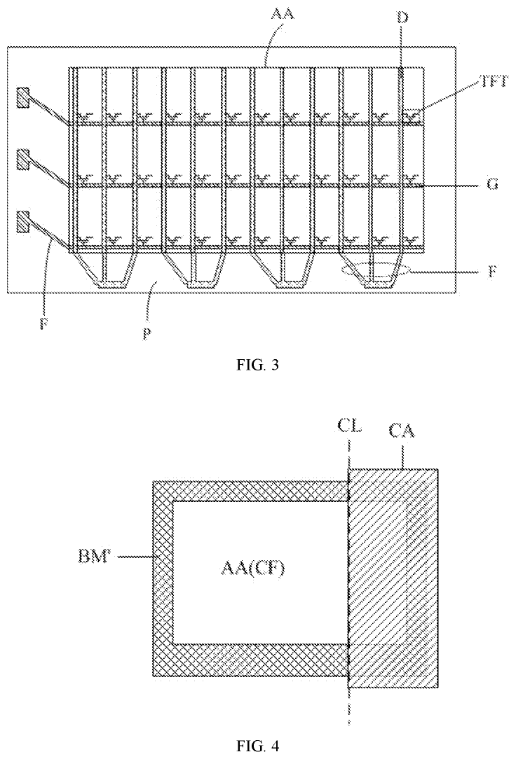

The liquid crystal display screen shown in FIG. 1 includes an opposite substrate (CF) shown in FIG. 2 and a display substrate (Array) shown in FIG. 3. The two substrates are paired to form a liquid crystal cell (Cell). As can be seen from FIG. 1, the LCD screen is divided into display region AA, sealing region S, and signal bonding region P according to functions. Optionally, as shown in FIG. 2, the opposite substrate (CF) is provided with sub-pixels (RGB) arranged in an array in the display region AA, and a black matrix (BM) used to define each sub-pixel (RGB). Optionally, the black matrix (BM) extends to form a circle of light-shielding layer (BM′) around the display region AA. The display substrate (Array) is provided with intersecting gate lines (G) and data lines (D) in the display region AA, transistors (TFTs) arranged in an array, and pixel electrodes electrically connected to transistors (TFT), etc.; the periphery of the display region AA mainly includes a signal bonding region P, and fanout lines (F) connecting the signal bonding region P to the display region AA.

The process of preparing an LCD screen with a target size by cutting an existing mass-produced LCD screen includes: for example, taking an 86-inch LCD screen and cutting it into a target size 63-inch LCD screen, firstly, use the complete set of masks for the 86-inch LCD screen to process the opposite substrate (CF) and the display substrate (Array), and then apply the frame sealant S on the 86-inch opposite substrate (CF) to define the 63-inch region, and then connect the 86-inch opposite substrate (CF) and the 86-inch display substrate (Array) to form a cell, and finally cut it to obtain a 63-inch LCD screen.

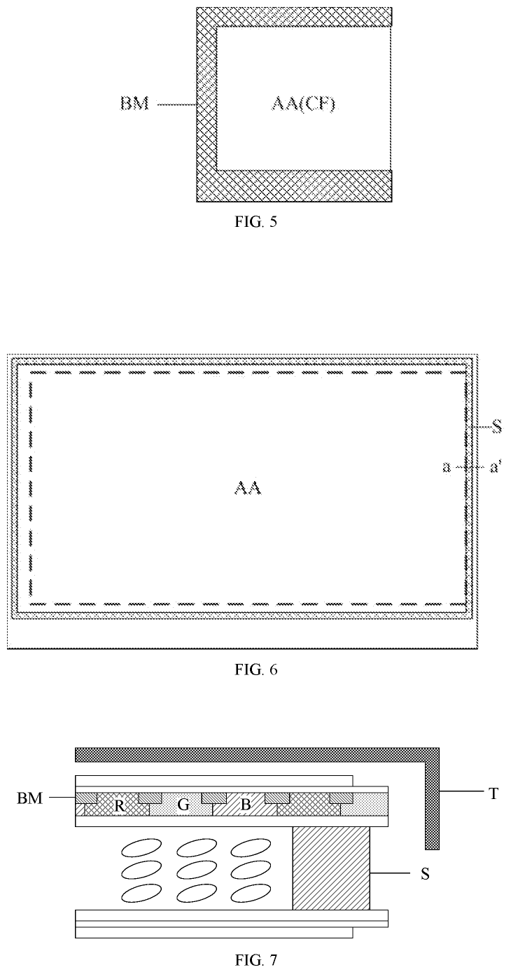

As shown in FIGS. 4 and 5, the light shielding layer (BM′) of the opposite substrate (CF) in the cutting region (CA) is cut off, which will cause light leakage at the edge formed by cutting (ie, the right edge). In the related art, the black tape (T) is attached to the edge formed by cutting for shading (as shown in FIG. 6 and FIG. 7). On the one hand, this will add an extra process and increase the cost. On the other hand, the black tape (T) will affect the appearance. After assembling the LCD display with the outer frame, the edges formed by cutting on the light emergent side of the LCD display are attached with black tape (T) so that they can fit with the outer frame, but the other edges form gaps with the outer frame, causing differences in peripheral image quality.

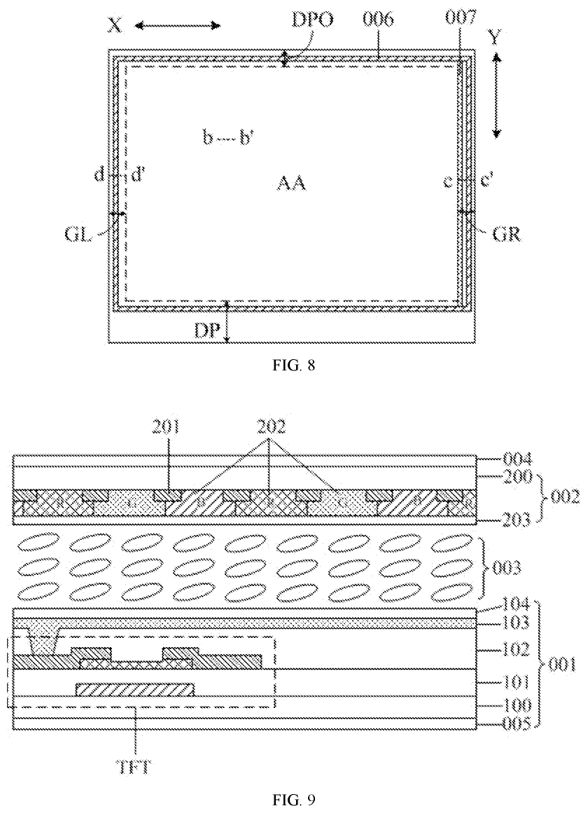

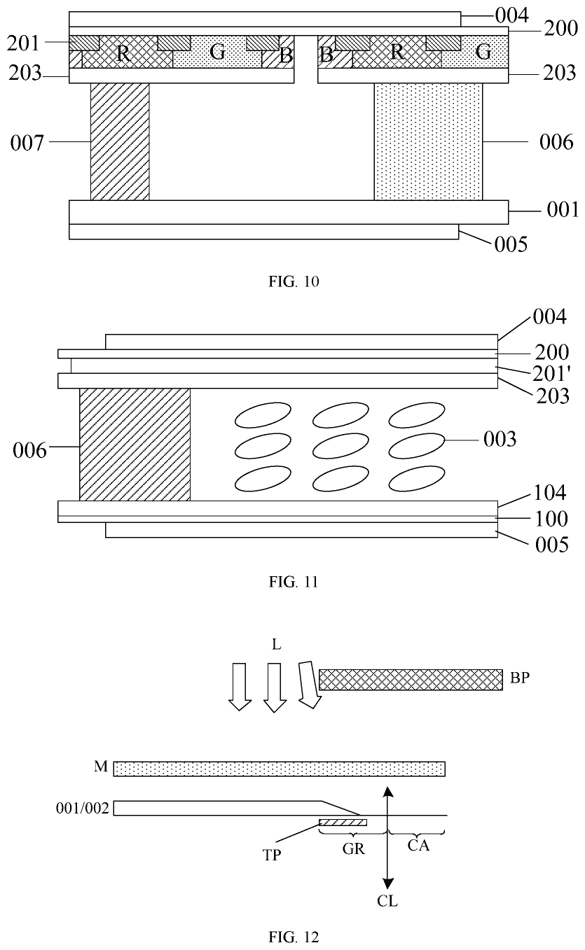

In order to improve the above technical problems existing in the related art, embodiments of the present disclosure provide a display panel, as shown in FIGS. 8 to 11, including a display region AA, and a selected frame region (such as GR) formed by cutting on at least one side of the display region AA. Optionally, the display panel includes: a display substrate 001 and an opposite substrate 002 opposite with each other, where both the display substrate 001 and the opposite substrate 002 cover the display region AA and the selected frame region (such as GR); a liquid crystal layer 003 between the display substrate 001 and the opposite substrate 002, and the liquid crystal layer 003 is at least located in the display region AA; a first polarizer 004 on one side of the opposite substrate 002 facing away from the liquid crystal layer 003, where the first polarizer 004 covers the display region AA and the selected frame region (such as GR); a second polarizer 005 on one side of the display substrate 001 facing away from the liquid crystal layer 003, where the second polarizer 005 covers the display region AA and the selected frame region (such as GR), a light transmission axis of the second polarizer 005 is crossed with a light transmission axis of the first polarizer 004; and at least one of the second polarizer 005, the first polarizer 004 or the liquid crystal layer 003 is configured to control the selected frame region (such as GR) to shield light.

In the above display panel provided by embodiments of the present disclosure, at least one of the liquid crystal layer 003, the first polarizer 004, or the second polarizer 005 controls the selected frame region (such as GR) formed by cutting for shielding light, which can effectively prevent light leakage in the selected frame region (such as GR) formed by cutting. Therefore, in the present disclosure, there is no need to attach black tape (T) for shielding light, thereby effectively avoiding defects such as increased steps, increased costs, and abnormal image quality caused by attaching black tape (T).

In some embodiments, the above-mentioned display panel provided by embodiments of the present disclosure, as shown in FIG. 8, may include a first sealant 006 and a second sealant 007; where the first sealant 006 surrounds the display region AA and an edge of the selected frame region (such as GR) adjacent to the display region AA; and the second sealant 007 separates the display region AA from the selected frame region (such as GR). Optionally, the width of the first sealant 006 and the width of the second sealant 007 each can be greater than or equal to 0.6 mm and less than or equal to 3 mm, for example, they may be 0.6 mm, 1 mm, 1.5 mm, 2 mm, 2.5 mm, or 3 mm etc.

In the present disclosure, the first sealant 006 defines the size of the target product, and the second sealant 007 forms a closed structure with the first sealant 006 in the selected frame region (such as GR), thereby separating the display region AA from the selected frame region (such as GR). The second sealant 007 can block the liquid crystal layer 003 of the display region AA, so that there is no liquid crystal layer 003 in the selected frame region (such as GR). In other words, the liquid crystal layer 003 has no pattern in the selected frame region (such as GR). In the display region AA, the image can be displayed normally through the optical rotation of the liquid crystal layer 003, as well as the first polarizer 004 and the second polarizer 005 that are orthogonal to each other. In the selected frame region (such as GR), since there is no liquid crystal layer 003 and the coverage of the first polarizer 004 and second polarizer 005 that are orthogonal to each other; therefore, the light passing through the second polarizer 005 is absorbed by the first polarizer 004 after being irradiated, forming a light-shielding region.

In some embodiments, in the above display panel provided by embodiments of the present disclosure, as shown in FIGS. 8 to 10, the opposite substrate 002 includes the black matrix 201 arranged towards the liquid crystal layer 003, the black matrix 201 extends from the display region AA to the selected frame region (such as GR); and, in the selected frame region (such as GR), the black matrix 201 is disconnected along an extending direction Y of the selected frame region (such as GR).

In the related art, the static electricity generated during the cutting process can be introduced into the black matrix (BM) in the display region (AA), causing the black matrix (BM) in the display region (AA) to be charged, affecting the normal display of the image. In the present disclosure, the black matrix 201 in the selected frame region on the cutting side is disconnected along the extension direction Y of the selected frame region (such as GR), thereby blocking the propagation path of static electricity to the display region AA and avoiding the electrification of the black matrix 201 in the display region AA after cutting. Optionally, as shown in FIGS. 8 and 11, the black matrix 201 can also be extended to other frame regions (such as GL, DP, DPO) outside the selected frame region (such as GR), so as to form a light-shielding effect in other frame regions (such as GL, DP, DPO) around the display region AA, avoiding bright lines caused by light leakage.

In some embodiments, in the above display panel provided by embodiments of the present disclosure, as shown in FIGS. 8 to 10, the opposite substrate 002 may further include a color resistance layer 202 and an first alignment layer 203 arranged in sequence on one side of the black matrix 201 facing the liquid crystal layer 003; the color resistance layer 202 and the first alignment layer 203 are simultaneously arranged in the display region AA and the selected frame region (such as GR); and at a position where the black matrix 201 is disconnected in the selected frame region (such as GR), both the color resistance layer 202 and the first alignment layer 203 are disconnected. The opposite substrate 002 of the present disclosure can be made using a complete set of masks for mass production of opposite substrates in related art. Therefore, there will be a color resistance layer 202 and a first alignment layer 203 on the side of the black matrix 201 facing the liquid crystal layer 003. By setting the position where the black matrix 201 is disconnected in the selected frame region (such as GR), the color resistance layer 202 and the first alignment layer 203 are both disconnected, which facilitates the use of laser cutting or other methods to cut the black matrix 201, the color resistance layer 202 and the first alignment layer 203 at the same position, thereby effectively introducing static electricity into the display region AA. Optionally, the color resistance layer 202 may include a red color resistance, a green color resistance, a blue color resistance, etc., which are not limited here.

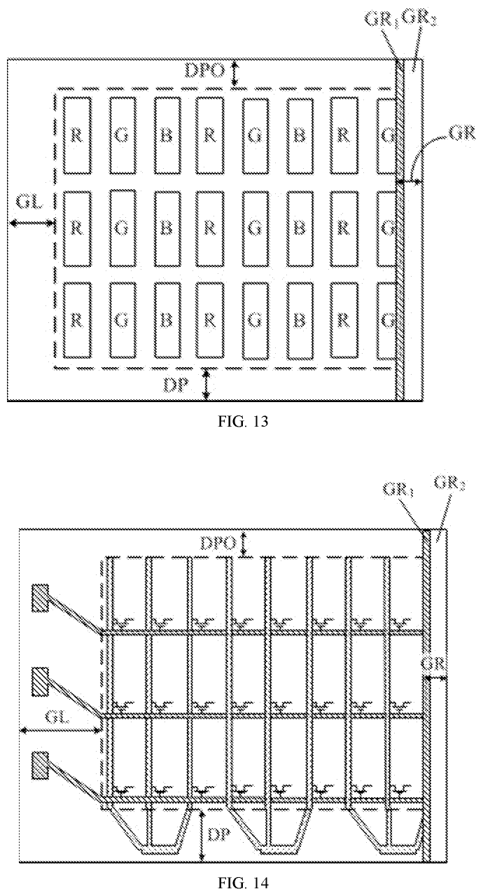

In some embodiments, as shown in FIG. 12, in the process of using a complete set of masks for mass production products to produce the opposite substrate 002 and the display substrate 001, the relative position between the mask plate M and the baffle BP can also be adjusted according to the size of the target product, so as to use baffle BP to block part of the light of the exposure lamp L, so that regions beyond the size of the target product are not exposed and form a pattern. Due to the transitional change in light intensity below the edge of the baffle BP, an irregular transition pattern TP will be formed on the edge, and the pattern will not be formed on the side of the transition pattern TP away from the display region AA due to complete obstruction by the baffle BP. Based on this, as shown in FIGS. 13 and 14, the selected frame region GR includes a transition pattern region GR₁ adjacent to the display region AA, and a patternless region GR₂ on one side of the transition pattern region GR₁ away from the display region AA; the film layers of the opposite substrate 002 in the transition pattern region GR₁ and the film layers of the opposite substrate 002 in the display region AA are of the same layers and made of the same materials; and the film layers of the display substrate 001 in the transition pattern region GR₁ and the film layers of the display substrate 001 in the display region AA are of the same layers and the same materials. Due to the absence of a black matrix 201 in the patternless region GR₂, static electricity during the cutting process to obtain the target size product will not be introduced into the display region AA.

Continuing to refer to FIG. 12, it can be seen that the light of the exposure lamp L has a certain degree of divergence, resulting in a larger vertical distance between the mask M and the baffle BP, a larger range of the transition exposure region, and a larger width of the transition pattern region GR₁, while the relative position between the mask M and the baffle BP remains unchanged in the horizontal direction. Based on this, in the present disclosure, the width of the transition pattern region GR₁ can be controlled by adjusting the vertical distance between the mask M and the baffle BP.

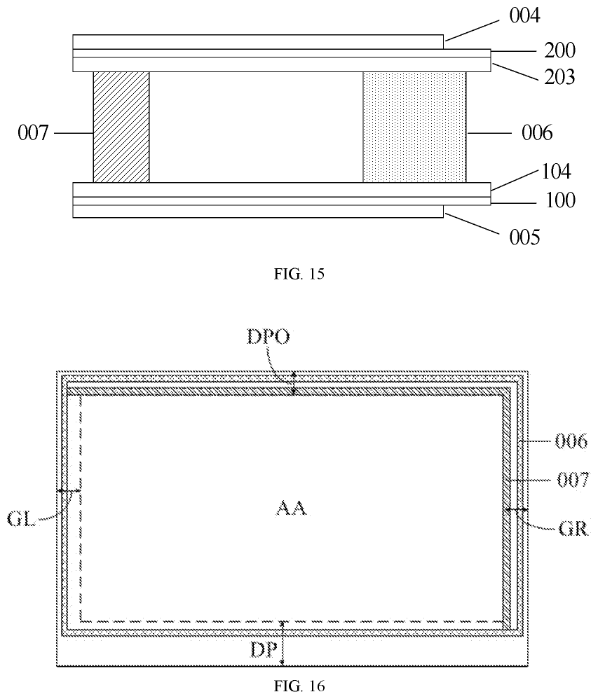

In some embodiments, in the above display panel provided by embodiments of the present disclosure, in a direction X perpendicular to an extension direction Y of the selected frame region, a ratio of a width of the transition pattern region GR₁ to a width of the selected frame region (such as GR) is greater than 0 and less than 0.001. For example, the width of the transition pattern region GR₁ is in the micrometer scale, which means that the width of the transition pattern region GR₁ ranges from a few micrometers to several tens of micrometers. The width of the selected frame region (such as GR) can be in the range of 1 mm to 3 mm. At this time, the proportion of the transition pattern region GR₁ to the selected frame region (such as GR) is extremely small, so that the selected frame region (such as GR) can be equivalent to the patternless region GR₂. The corresponding cross-sectional view is shown in FIG. 15.

As can be seen from FIG. 15, the opposite substrate 002 in the selected frame region (such as GR) is only provided with the first alignment layer 203. Combined with the cross-sectional views of other frame regions (such as GL) outside the selected frame region (such as GR) shown in FIG. 11, it can be seen that the opposite substrate 002 in other frame regions (such as GL) outside the selected frame region (such as GR) is only provided with the black matrix 201 as the light shielding layer 201′ and a first alignment layer 203. By comparison, it can be seen that in each frame region around the display region AA, the height difference between the film layers of the opposite substrate 002 lies in the thickness of the black matrix 201. Since the thickness of the conventional black matrix 201 is 1 μm, the height difference can be ignored. That is to say, in each frame region around the display region AA, the film layers of the opposite substrate 002 can be regarded as having the same height, which is conducive to using the same spacer ball to support at the positions of the display region AA and the first sealant 006 and at the position of the second sealant 007 to maintain a uniform cell gap. In the related art, the spacer columns are used for support in the display region AA, and spacer balls are used for support in the sealant frame region (i.e. the location of the sealant). Two types of raw materials are used, which have high costs and require adjusting the cell gap through the combination of the spacer columns and the spacer balls, increasing the difficulty of the process. In the present disclosure, the same spacer balls to support at the positions of the display region AA the first sealant 006 and the position of the second sealant 007 to maintain a uniform cell gap, with low cost and simple process.

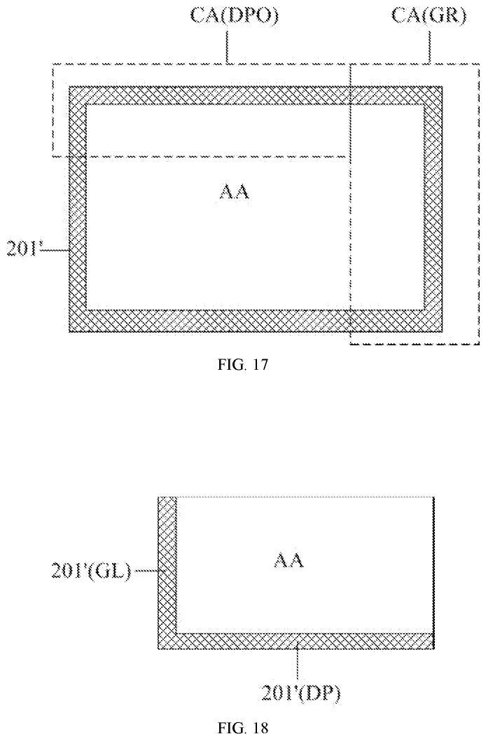

In some embodiments, in the above-mentioned display panel provided by embodiments of the present disclosure, as shown in FIGS. 8 and 16, the display region AA may also include a first frame region GL provided with a gate driving circuit (GOA) and a second frame region DP configured to bond chips (IC), the first frame region GL is adjacent to the second frame region DP; the selected frame region is located on one side of the display region AA away from the first frame region GL, and/or, the selected frame region is located on one side of the display region AA away from the second frame region DP. That is, the selected frame region may be the frame region GR on the opposite side of the first frame region GL, and/or, be the frame region DPO on the opposite side of the second frame region DP. As shown in FIGS. 17 and 18, when the selected frame regions are the frame region GR on the opposite side of the first frame region GL and the frame region DPO on the opposite side of the second frame region DP, only the first frame region GL and the second frame region DP have a light-shielding layer 201′ after cutting. In order to avoid light leakage in the selected frame region (such as GR and DPO), the second sealant 007 can be L-shaped as shown in FIG. 16 to separate the selected frame regions on both sides from the display region AA, so that the selected frame regions (such as GR and DPO) do not have the liquid crystal layer 003. Therefore, the orthogonal first polarizer 004 and the second polarizer 005 can be used to achieve light shielding effect.

In some embodiments, in the above-mentioned display panel provided by embodiments of the present disclosure, there is a first distance between the first sealant 006 and the second sealant 007 on the same side of the display region AA; the first distance can be equal to the width of the light-shielding layer 201′ on the opposite side of the second sealant 007. For example, the selected frame region is only the frame region GR on the opposite side of the first frame region GL, then the side of the display region AA away from the first frame region GL, the first distance between the first sealant 006 and the second sealant 007 can be equal to the width of the light shielding layer 201′ in the first frame region GL, ensuring that the first frame region GL is symmetrical with the selected frame region (GR) on the opposite side.

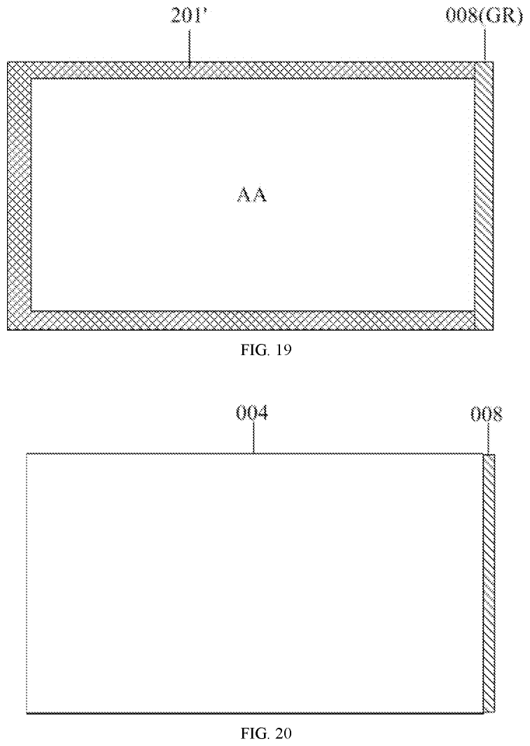

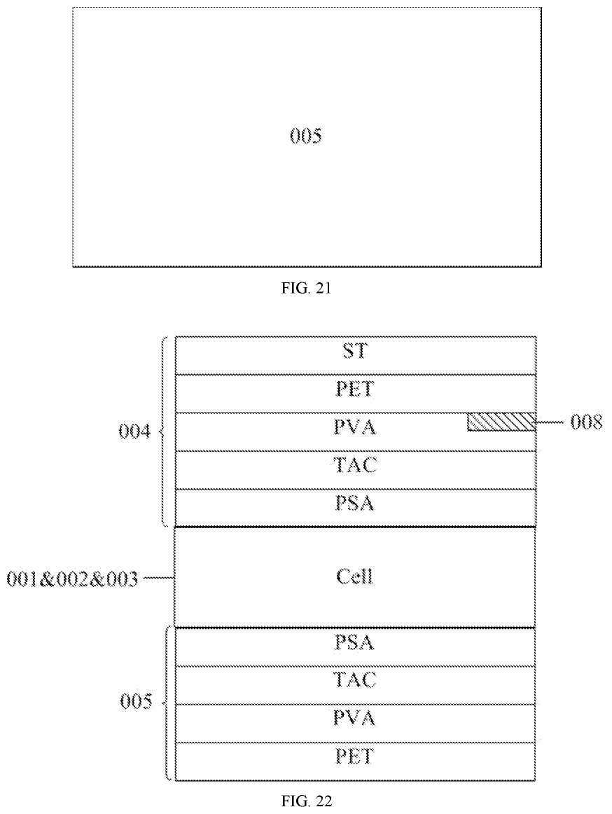

In some embodiments, in the above-mentioned display panel provided by embodiments of the present disclosure, if the display panel is a borderless product, it is not conducive to use the first sealant 006 and the second sealant 007 to define the region without LCD. Based on this, in order to prevent light leakage in the selected frame region (such as GR) in borderless products, in the above-mentioned display panel provided by embodiments of the present disclosure, as shown in FIG. 6, FIG. 19 to FIG. 22, at least one of the first polarizer 004 or the second polarizer 005 includes a light-shielding structure 008; and the light-shielding structure 008 at least partially overlaps the selected frame region (such as GR). Optionally, in order to achieve a better light-shielding effect, the light-shielding structure 008 completely overlaps the selected frame region (such as GR).

It should be understood that for products with slightly larger borders other than borderless product, not only can the first sealant 006 and the second sealant 007 be used to define a region without liquid crystal for shielding light, but also the light-shielding structure 008 can be used to achieve light shielding.

In some embodiments, the first polarizer 004 and the second polarizer 005 provided by embodiments of the present disclosure may respectively include a polarizing base layer PVA, a pressure-sensitive adhesive layer PAS, a first support layer TAC, and a second support layer PET. Optionally, the first polarizer 004 may further include a surface treatment layer ST, which can play a role in anti-reflective, anti-glare and other functions. Among the film layers of the first polarizer 004 and the second polarizer 005, the polarizing base layer PVA is soft and easy to operate, so the light-shielding structure 008 can be embedded in the polarizing base layer PVA.

In some embodiments, in the above display panel provided by embodiments of the present disclosure, as shown in FIG. 9, the display substrate 001 may further include a second base substrate 100, a gate insulating layer 101, a flat layer 102, a pixel electrode 103, a second alignment layer 104 and so on. Other essential components of the display panel should be understood by those of ordinary skill in the art, and will not be described in detail here, nor should they be used to limit the present disclosure.

Based on the same inventive concept, embodiments of the present disclosure provide a manufacturing method for the above-mentioned display panel, which may include the following steps.

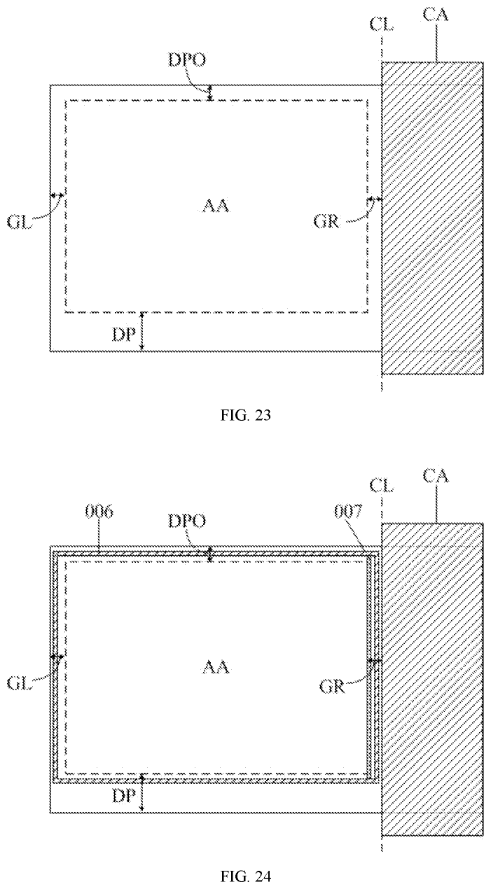

In the first step, providing a display substrate 001 of a first size and an opposite substrate 002 of the first size; where the display substrate 001 of the first size and the opposite substrate 002 of the first size include the display region AA, the selected frame region (such as GR) on at least one side of the display region AA, and a cutting region CA on one side of the selected frame region (such as GR) away from the display region AA, as shown in FIG. 23.

In the second step, forming a sealant (as shown in FIG. 24) on the opposite substrate 002 of the first size, and instilling liquid crystal in at least the display region AA of the display substrate 001 of the first size. Optionally, the sealant only includes the first sealant 006, or the sealant includes both the first sealant 006 and the second sealant 007. It should be understood that the fluidity of liquid crystal at room temperature is poor, so the instilled liquid crystals hardly diffuse on the display substrate 001.

In the third step, pairing the display substrate 001 of the first size and the opposite substrate 002 of the first size to form a display panel of the first size including the liquid crystal layer. Optionally, after pairing the display substrate 001 of the first size with t the opposite substrate 002 of the first size, heating treatment can be carried out to allow liquid crystal flow to fill the entire liquid crystal cell.

In the fourth step, removing the cutting region CA of the display panel of the first size to obtain a display panel of a second size.

In the fifth step, attaching a first polarizer 004 on one side of the opposite substrate 002 of the display panel of the second size, and attaching a second polarizer 005 on one side of the display substrate 001; where a light transmission axis of the second polarizer 005 is crossed with a light transmission axis of the first polarizer 004; and at least one of the second polarizer 005, the first polarizer 004 or the liquid crystal layer 003 is configured to control the selected frame region (such as GR) to shield light to obtain the display panel provided by the embodiments of the present disclosure.

In some embodiments, in the above-mentioned manufacturing method provided by embodiments of the present disclosure, the forming the sealant on the opposite substrate of the first size, and instilling liquid crystal in at least the display region of the display substrate of the first size, which may include the following steps: as shown in FIG. 24, forming a first sealant 006 on edges of the opposite substrate 002 of the first size in a complete circle; and at the same time, forming a second sealant 007 on an edge of the selected frame region (such as GR) adjacent to the display region AA; where the first sealant 006 surrounds the display region AA and an edge of the selected frame region (such as GR) adjacent to the display region AA; and the second sealant 007 separates the display region AA from the selected frame region (such as GR); and instilling liquid crystal at a position corresponding to the display region enclosed by the first sealant 006 and the second sealant 007 on the display substrate 001 of the first size outside the selected frame region (such as GR).

In some embodiments, in the above-mentioned manufacturing method provided by embodiments of the present disclosure, the providing the display substrate of the first size and the opposite substrate of the first size, which can be implemented in the following manner: forming film layers of the display substrate 001 of the first size in the display region AA, the selected frame region (such as GR) on at least one side of the display region AA, and the cutting region CA on one side of the selected frame region (such as GR) away from the display region AA by using a mask corresponding to the display substrate 001 of the first size; and making film layers of the opposite substrate 002 of the first size in the display region AA, the selected frame region (such as GR) and the cutting region CA by using a mask corresponding to the opposite substrate 002 of the first size. Correspondingly, after providing the opposite substrate 002 of the first size and before forming the sealant on the opposite substrate 002 of the first size, the method further includes steps: disconnecting, along the extension direction Y of the selected frame region (such as GR), the film layers in the selected frame region (such as GR) on the opposite substrate 002 of the first size.

In some embodiments, in the above-mentioned manufacturing method provided by embodiments of the present disclosure, the providing the display substrate of the first size and the opposite substrate of the first size, which can be implemented in the following manner. As shown in FIG. 12, film layers of the display substrate of the first size are formed in the display region AA and the transition pattern region GR₁ by using a mask M corresponding to the display substrate 001 of the first size and an baffle BP that blocks the selected frame region (such as GR) and the cutting region CA; and film layers of the opposite substrate 0022 of the first size are formed in the display region AA and the transition pattern region GR₁ by using a mask M corresponding to the opposite substrate 002 of the first size and the baffle BP that blocks the selected frame region (such as GR) and the cutting region CA. The selected frame region (such as GR) is located on at least one side of the display region AA, the cutting region CA is located on one side of the selected frame region (such as GR) away from the display region AA, and the transition pattern region GR₁ is located in the selected frame region (such as GR) and adjacent to the display region AA; and a width of the transition pattern region GR₁ in a direction X perpendicular to an extension direction Y of the selected frame region (such as GR) is positively correlated with a distance from the mask M to the baffle BP.

In some embodiments, in the above-mentioned manufacturing method provided by embodiments of the present disclosure, after removing the cutting region of the display panel of the first size to obtain a display panel of a second size, and before attaching a first polarizer on one side of the opposite substrate of the display panel of the second size, and attaching a second polarizer on one side of the display substrate, which may further include the following steps: providing the first polarizer and the second polarizer; where at least one of the first polarizer or the second polarizer includes a light-shielding structure arranged corresponding to the selected frame region.

It should be noted that when the light-shielding structure embedded in the polarizer is used for light-shielding, since the cutting region of the first size display panel will occupy part of the display region of the first size display panel, in order to prevent the liquid crystal leakage during the cutting process, the first size display panel can be cold frozen to freeze the liquid crystal layer 003, and then the cutting region can be cut off. In the solution of using the first sealant and the second sealant to achieve light shielding, since the liquid crystal layer in the first size display panel is located in the display region defined by the first sealant and the second sealant, there is no liquid crystal in the cutting region. Therefore, before cutting off the cutting region, there is no need for the first size display panel to undergo freezing treatment.

In some embodiments, in the above-mentioned manufacturing method provided by embodiments of the present disclosure, after providing the display substrate 001 of the first size and the opposite substrate 002 of the first size, and before forming the sealant on the opposite substrate 002 of the first size and instilling liquid crystal in at least the display region AA of the display substrate 001 of the first size, polyimide (PI) coating can also be completed on the display substrate 001 and the opposite substrate 002 respectively, and the polyimide film can be rubbed to form a second alignment layer 104 on the display substrate 001 and a first alignment layer 203 on the opposite substrate 002.

Based on the same inventive concept, embodiments of the present disclosure further provide a display apparatus, including the above display panel provided by embodiments of the present disclosure. Since the principle of the display apparatus to solve the problem is similar to the principle of the above-mentioned display panel to solve the problem, the implementation of the display apparatus provided by embodiments of the present disclosure can be referred to the implementation of the above-mentioned display panel, and the repeated details will not be repeated.

In some embodiments, the above-mentioned display apparatus provided by embodiments of the present disclosure may further include a backlight module, and the display panel is disposed on the light emergent side of the backlight module. The backlight module can be a direct-lit backlight module or an edge-lit backlight module. Optionally, the edge-lit backlight module may include equal light bars, stacked reflective sheets, light guide plates, diffusion sheets, prism groups, etc. The light bars are located on one side in the thickness direction of the light guide plate. The direct-lit backlight module may include a matrix light source, and a reflective sheet, a diffusion plate, a brightness enhancement film, etc. that are stacked on the light emergent side of the matrix light source. The reflective sheet includes openings that are positioned opposite to the positions of lamp beads in the matrix light source. The lamp beads in the light bars and the lamp beads in the matrix light source can be light-emitting diodes (LEDs), such as micro-LEDs, Mini LED, etc. Miniature light-emitting diodes at the sub-millimeter or even micron level are self-luminous devices like organic light-emitting diodes (OLEDs). Like organic light-emitting diodes, it has a series of advantages such as high brightness, ultra-low latency, and ultra-large viewing angle. Moreover, due to the fact that inorganic light-emitting diodes emit light based on metal semiconductors with more stable properties and lower resistance, they have the advantages of lower power consumption, better resistance to high and low temperatures, and longer service life compared to organic light-emitting diodes that emit light based on organic compounds. When micro light-emitting diodes are used as backlight sources, more precise dynamic backlighting effects can be achieved, effectively improving screen brightness and contrast while also solving the glare phenomenon caused by traditional dynamic backlighting between bright and dark regions of the screen, optimizing the visual experience.

In some embodiments, the above display apparatus provided by embodiments of the present disclosure can be applied to projectors, 3D printers, virtual reality devices, mobile phones, tablet computers, televisions, monitors, notebook computers, digital photo frames, navigators, smart watches, fitness wristbands, personal digital assistants and other products or components with display functions. Optionally, the above-mentioned display apparatus provided by embodiments of the present disclosure may include but is not limited to: a radio frequency unit, a network module, an audio output & input unit, a sensor, a display unit, a user input unit, an interface unit, a control chip and other components. Optionally, the control chip is a central processor, a digital signal processor, a system on chip (SoC), etc. For example, the control chip may also include a memory, a power module, etc., and realize power supply and signal input and output functions through additional wires, signal lines, etc. For example, the control chip may also include hardware circuits and computer executable codes, etc. Hardware circuits may include conventional very large scale integration (VLSI) circuits or gate arrays as well as existing semiconductors such as logic chips, transistors, or other discrete components; hardware circuits may also include field programmable gate arrays, programmable array logic, Programmable logic devices, etc. Moreover, those skilled in the art can understand that the above structure does not constitute a limitation on the above display apparatus provided by embodiments of the present disclosure. In other words, the above display apparatus provided by embodiments of the present disclosure may include more or less of components disclosed above, or combinations of certain components, or different arrangements of components.

Although the present disclosure has described preferred embodiments, it should be understood that those skilled in the art can make various changes and modifications to the disclosed embodiments without departing from the spirit and scope of the disclosed embodiments. Thus the present disclosure is also intended to encompass these modifications and variations therein as long as these modifications and variations to the present disclosure come into the scope of the claims of the present disclosure and their equivalents.

1. A display panel, comprising a display region and a selected frame region located on at least one side of the display region, wherein the display panel comprises:
a display substrate and an opposite substrate opposite with each other, wherein both the display substrate and the opposite substrate cover the display region and the selected frame region;
a liquid crystal layer between the display substrate and the opposite substrate, wherein the liquid crystal layer is at least located in the display region;
a first polarizer on one side of the opposite substrate facing away from the liquid crystal layer, wherein the first polarizer covers the display region and the selected frame region; and
a second polarizer on one side of the display substrate facing away from the liquid crystal layer, wherein the second polarizer covers the display region and the selected frame region, a light transmission axis of the second polarizer is crossed with a light transmission axis of the first polarizer; and at least one of the second polarizer, the first polarizer or the liquid crystal layer is configured to control the selected frame region to shield light.

2. The display panel according to claim 1, further comprising: a first sealant and a second sealant;
wherein the first sealant surrounds the display region and an edge of the selected frame region adjacent to the display region; and the second sealant separates the display region from the selected frame region.

3. The display panel according to claim 2, wherein the liquid crystal layer has no pattern in the selected frame region.

4. The display panel according to claim 3, wherein the opposite substrate comprises a black matrix arranged towards the liquid crystal layer, the black matrix extends from the display region to the selected frame region; and, in the selected frame region, the black matrix is disconnected along an extending direction of the selected frame region.

5. The display panel according to claim 4, wherein the opposite substrate further comprises: a color resistance layer and an alignment layer arranged in sequence on one side of the black matrix facing the liquid crystal layer;
the color resistance layer and the alignment layer are simultaneously arranged in the display region and the selected frame region; and
at a position where the black matrix is disconnected in the selected frame region, both the color resistance layer and the alignment layer are disconnected.

6. The display panel according to claim 3, wherein the selected frame region comprises a transition pattern region adjacent to the display region, and a patternless region on one side of the transition pattern region away from the display region;
film layers of the opposite substrate in the transition pattern region and film layers of the opposite substrate in the display region are of the same layers and made of the same materials; and
film layers of the display substrate in the transition pattern region and film layers of the display substrate in the display region are of the same layers and the same materials.

7. The display panel according to claim 6, wherein, in a direction perpendicular to an extension direction of the selected frame region, a ratio of a width of the transition pattern region to a width of the selected frame region is greater than 0 and less than 0.001.

8. The display panel according to claim 2, further comprising: a first frame region provided with a gate driving circuit and a second frame region configured to bond chips, the first frame region is adjacent to the second frame region;
the selected frame region is located on one side of the display region away from the first frame region, and/or, the selected frame region is located on one side of the display region away from the second frame region.

9. The display panel according to claim 8, wherein the first frame region and the second frame region respectively comprise light-shielding layers;
on the same one side of the display region, a first distance is provided between the first sealant and the second sealant; and
the first distance is equal to a width of a light-shielding layer on an opposite side of the second sealant.

10. The display panel according to claim 1, wherein at least one of the first polarizer or the second polarizer comprises a light-shielding structure; and
the light-shielding structure at least partially overlaps the selected frame region.

11. The display panel according to claim 10, wherein the first polarizer and the second polarizer comprise polarizing base layers; and the light shielding structure is embedded in at least one of the polarizing base layers.

12. A manufacturing method for the display panel according to claim 1, comprising:
providing a display substrate of a first size and an opposite substrate of the first size; wherein the display substrate of the first size and the opposite substrate of the first size comprise the display region, the selected frame region on at least one side of the display region, and a cutting region on one side of the selected frame region away from the display region;
forming a sealant on the opposite substrate of the first size, and instilling liquid crystal in at least the display region of the display substrate of the first size;
pairing the display substrate of the first size and the opposite substrate of the first size to form a display panel of the first size comprising the liquid crystal layer;
removing the cutting region of the display panel of the first size to obtain a display panel of a second size; and
attaching the first polarizer on one side of the opposite substrate of the display panel of the second size, and attaching the second polarizer on one side of the display substrate; wherein the light transmission axis of the second polarizer is crossed with the light transmission axis of the first polarizer; and at least one of the second polarizer, the first polarizer or the liquid crystal layer is configured to control the selected frame region to shield light to obtain the display panel according to claim 1.

13. The manufacturing method according to claim 12, wherein the forming the sealant on the opposite substrate of the first size, and instilling liquid crystal in at least the display region of the display substrate of the first size, comprises:
forming a first sealant on edges of the opposite substrate of the first size in a complete circle; and at the same time, forming a second sealant on an edge of the selected frame region adjacent to the display region; wherein the first sealant surrounds the display region and an edge of the selected frame region adjacent to the display region; and the second sealant separates the display region from the selected frame region; and
outside the selected frame region, instilling liquid crystal at a position corresponding to the display region enclosed by the first sealant and the second sealant on the display substrate of the first size.

14. The manufacturing method according to claim 12, wherein the providing the display substrate of the first size and the opposite substrate of the first size, further comprises:
forming film layers of the display substrate of the first size in the display region, the selected frame region on at least one side of the display region, and the cutting region on one side of the selected frame region away from the display region by using a mask corresponding to the display substrate of the first size; and
making film layers of the opposite substrate of the first size in the display region, the selected frame region and the cutting region by using a mask corresponding to the opposite substrate of the first size.

15. The manufacturing method according to claim 14, wherein after the providing the opposite substrate of the first size and before the forming the sealant on the opposite substrate of the first size, the method further comprises:
disconnecting, along the extension direction of the selected frame region, the film layers in the selected frame region on the opposite substrate of the first size.

16. The manufacturing method according to claim 12, the providing the display substrate of the first size and the opposite substrate of the first size, further comprises:
forming film layers of the display substrate of the first size in the display region and a transition pattern region by using a mask corresponding to the display substrate of the first size and an exposure baffle that blocks the selected frame region and the cutting region; and
forming film layers of the opposite substrate of the first size in the display region and the transition pattern region by using a mask corresponding to the opposite substrate of the first size and the exposure baffle;
wherein the selected frame region is located on at least one side of the display region, the cutting region is located on one side of the selected frame region away from the display region, and the transition pattern region is located in the selected frame region and adjacent to the display region; and a width of the transition pattern region in a direction perpendicular to an extension direction of the selected frame region is positively correlated with a distance from the mask to the exposure baffle.

17. The manufacturing method according to claim 12, wherein after removing the cutting region of the display panel of the first size to obtain a display panel of a second size, and before attaching the first polarizer on one side of the opposite substrate of the display panel of the second size, and attaching the second polarizer on one side of the display substrate, the method further comprises:
providing the first polarizer and the second polarizer; wherein at least one of the first polarizer or the second polarizer comprises a light-shielding structure arranged corresponding to the selected frame region.

18. A display apparatus, comprising the display panel according to claim 1.

19. The display panel according to claim 1, wherein a width of the first sealant and a width of the second sealant each are greater than or equal to 0.6 mm and less than or equal to 3 mm.

20. The display panel according to claim 1, wherein a width of the selected frame region is in the range of 1 mm to 3 mm.
